(19) United States
(12) Patent Application Publication
(10) Pub. No.: US 2013/0251475 A1
(43) Pub. Date: Sep. 26, 2013

(54) DEVICE FOR FASTENING DOOR OR FLAP HINGES OR OTHER ELEMENTS TO THE DOORS OR FLAPS OR TO THE BODYWORK OF MOTOR VEHICLES

(71) Applicant: Thorsten Schraer, Gerolsbach (DE)

(72) Inventor: Thorsten Schraer, Gerolsbach (DE)

(73) Assignee: RUIA GLOBAL FASTENERS AG, Neuss (DE)

(21) Appl. No.: 13/992,942

(22) PCT Filed: Dec. 9, 2011
(86) PCT No.: PCT/DE2011/050056

§ 371 Date: Jun. 10, 2013

(30) Foreign Application Priority Data
Dec. 10, 2010 (DE) 20 2010 016 444.3

(51) Int. Cl. F16B 33/00

(52) U.S. Cl. CPC F16B 33/00
USPC 411/366.1

(57) ABSTRACT

A device for fastening side impact supports, and door or flap hinges (10) to the doors (12) or flaps or to the bodywork of motor vehicles, with a screw (141) which extends through an opening in the door (12), the flap or the bodywork sheet and through an opening in the side impact support or hinge (10), and is secured by a nut (16), in which a hollow absorber element (18) is arranged between the nut (16) and the sheet of the door (12), the flap or the bodywork or the side impact support or the hinge (10), which absorber element is penetrated by the screw (14′) and has side walls (20) which run substantially parallel to the axis of rotation of the screw (14′), and two abutment surfaces (22, 26, 34) each running perpendicularly to the axis of rotation of the screw (14′), wherein the one abutment surface (26, 34) is supported on the sheet of the door (12), the flap or the bodywork or the side impact support or the hinge (10) while the other abutment surface (22) bears the nut (16). The invention also relates to similar devices in which an inner thread is provided on the absorber element instead of the nut.

### TECHNICAL AREA

The present invention relates to devices for fastening door or flap hinges or other elements, such as side impact supports, to the doors or flaps or to the bodywork of motor vehicles.

### PRIOR ART

Generally, side impact supports or door hinges of this type are fastened to the panel of the door and to the panel of the bodywork by means of one or more screws and associated nuts. The fastening according to the prior art, as shown in FIG. 1, leads to a rigid connection which, in particular, in the event of a side impact accident has to absorb the entire loads. The drawback of a rigid connection of this type is that the deformable region is exclusively described by the configuration of the door itself. No additional movement is possible to absorb kinetic energy from the object penetrating laterally. This also means that the connection of the door hinge has to absorb the entire energy introduced. It is known from earlier crash tests with doors that the connection is frequently destroyed in the event of side impact accidents in that, for example, the screw and nut are pulled out of the panel material of the door.

The object of the present invention is therefore to improve the fastening of door or flap hinges or side impact supports on the doors or flaps or on the bodywork of motor vehicles in such a way that these fastenings can absorb energy and the load on the door panel and the opposing bodywork panel can thereby be reduced, and to simultaneously reduce the deformation energy in a controlled manner in the event of a side impact.

### PRESENTATION OF THE INVENTION

According to the invention, this object can be achieved, for example, in that arranged between the nut and the panel of the door, the flap or the bodywork or the side impact support or the hinge is a hollow absorber element, which is penetrated by the screw and has side walls, which substantially run parallel to the rotational axis of the screw, namely abutment faces in each case running perpendicular to the rotational axis of the screw, one abutment face being supported on the panel of the door, the flap or the bodywork or the hinge, while the other abutment face carries the nut.

To simplify the production, it is preferred here for the absorber element to be hollow cylindrical, so the side walls form the lateral surface of the cylinder.

In order to achieve easier and more controlled deformation of the absorber element in the event of an accident, it is particularly preferred for the side walls to be configured with a corrugated profile or be pre-compressed.

On the other hand, if it is wished to achieve a higher absorption of energy of the absorber element, it is preferred if the absorber element is completely or partly filled with a foam, for example a foamed plastics material, such as polyurethane foam.

It may be advantageous from the manufacturing point of view, if the absorber element is welded to the panel of the door, the flap or the bodywork or the side impact support or the hinge.

A particularly high stability of the absorber element can be achieved if the abutment face, which faces the panel of the door, the flap or the bodywork or the side impact support or the hinge, of the absorber element is formed by a guide plate welded to the side walls.

A particularly economical and simple production is produced if the abutment face, which faces the panel of the door, the flap or the bodywork or the side impact support or the hinge, is formed by a right-angled folded edge of the side walls.

Furthermore, the production can be facilitated in that the nut is made captive by being welded, soldered, riveted or glued to the abutment face facing it.

In order as far as possible to avoid a jamming of the door in the event of an accident, it is particularly preferred if the panel of the door, the flap or the bodywork and the hinge is in each case provided with one or more guides, for example by openings, which oppose one another in each case in the assembled state, are virtually the same size and through which pins are inserted in the assembled state. It can thus be ensured that the side impact support or the hinge remains in its place even in the event of a deformation of the absorber element and, in this manner, the door is prevented from jamming.

It is particularly preferred here if the pins are additionally supported on the inner face of the side walls.

Alternatively, the object according to the invention can also be achieved in that the screw additionally extends through a hollow absorber element, which has side walls, which extend substantially parallel to the rotational axis of the screw, an abutment face, which runs perpendicular to the rotational axis of the screw and is supported on the panel of the door, the flap or the bodywork or the side impact support or the hinge, and an internal thread for the screw on the side opposing the abutment face.

From the manufacturing point of view it is also particularly preferred here to make the absorber element hollow cylindrical, so the side walls form the lateral surface of the cylinder.

In order to ensure a particularly well controlled deformation, the side walls may be configured with a corrugated profile or be pre-compressed.

If a particularly high absorption of energy of the absorber element is desired, the latter can be completely or partly filled with a foam, for example a foamed plastics material, such as polyurethane foam.

To simplify the assembly, the absorber element can be welded, soldered, riveted or glued to the panel of the door, the flap or the bodywork or the side impact support or the hinge.

A particularly stable embodiment of the absorber element is produced when the abutment face of the absorber element is formed by a guide plate welded to the side walls.

Particularly simple production is made possible when the abutment face is formed by a right-angled folded edge of the side walls.

Especially in this embodiment of the invention, a particularly economical production emerges when the absorber element is produced as a sheet metal formed part, and the internal thread is configured in a tube.

In order to achieve particularly great side stability of the fastening according to the invention, it is preferred that the panel of the door, the flap or the bodywork and the hinge or the side impact support be provided, in each case, with one or more guides, for example by openings, which oppose one another in each case in the assembled state, are virtually the same size and through which pins are inserted in the assembled state.

These pins are preferably additionally supported on the inner face of the side walls.

### SHORT DESCRIPTION OF THE FIGURES OF THE DRAWINGS

The present invention will be described in more detail below with the aid of the embodiments shown in the drawings.

In the drawings:

FIG. 1 shows a door connection according to the prior art;

FIG. 2 shows a door connection with separate nut, welded absorber element and guide pins in the assembled state;

FIG. 3 shows the embodiment of FIG. 2 after an accident, in which the absorber element has deformed;

FIG. 4 shows a further embodiment of the fastening according to the invention, in which the absorber element is configured as a panel component with a welded guide plate, in the assembled state, and

FIG. 5 shows the embodiment of FIG. 4 after an accident, which has led to the deformation of the absorber element.

### BEST METHOD FOR CARRYING OUT THE INVENTION

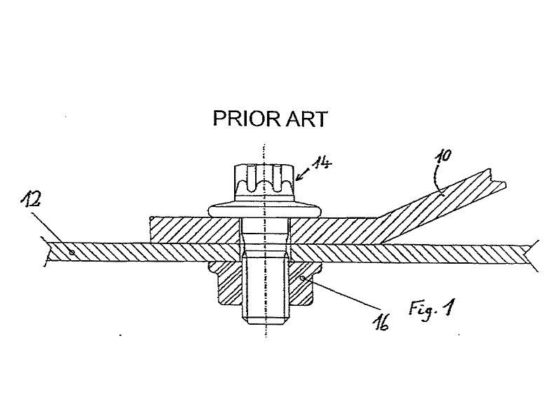

For better explanation of the present invention, FIG. 1 firstly shows the fastening of a door hinge 10 to a door panel 12, corresponding to the previous prior art. The fastening takes place here by means of a screw 14, which extends through a respective opening in the door hinge 10 and the door panel 12 and which is screwed on the side opposing its head using a nut 16, preferably a weld nut. The same reference numerals will be used below for the same components, in order to increase the comprehensibility of the description.

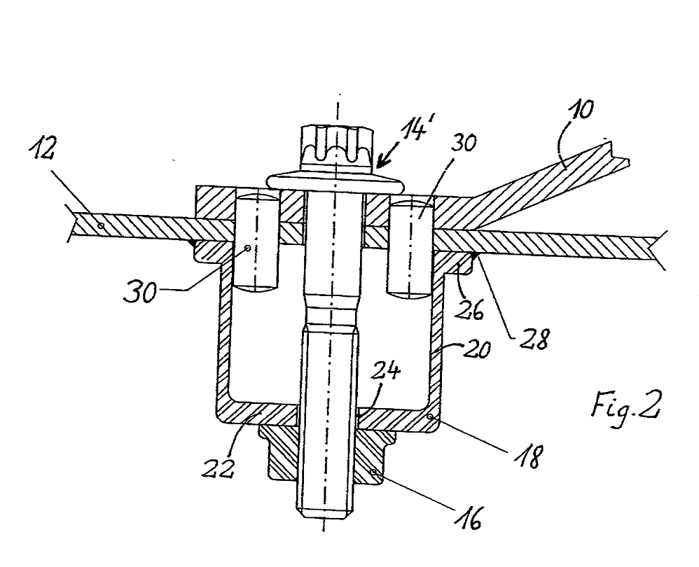

FIG. 2 shows a first embodiment according to the invention of a door fastening. The door hinge 10 is also connected here to the door panel by means of a screw 14′, which, in each case, extends through a respective opening in the hinge 10 and the door panel 12 and is screwed by means of a nut, preferably a weld nut 16. This screw 14′ has to be longer here than in the prior art.

An absorber element 18 is namely arranged here between the nut 16 and the door panel 12 according to the invention. Said absorber element is in the form of a hollow cylinder and the side walls 20 of the absorber element 18 are formed here by the lateral surface of the hollow cylinder. These side walls 20 are arranged coaxially here with respect to the rotational axis of the screw 14′. The top face 22 remote from the door panel 12 forms the abutment for the nut 16. The screw 14′ penetrates the hollow cylindrical-shaped absorber element 18 coaxially and extends through an opening 24 in the absorber element 18 and out of it. In order to be able to achieve easier deformability of the absorber element 18, the side walls 20 may be configured with a corrugated profile or be pre-compressed.

Depending on the requirements in relation to assembly, the screw 14′ can, of course, also be installed the other way round, in other words, the head of the screw 14′ is then supported on the top face 22 of the absorber element 18, while the nut rests on the door hinge 10, or, if it is configured as a weld nut, it can be welded there. The absorber element 18 is supported by means of a right-angled folded edge 26 on the door panel 12. In order to simplify the production, these folded edges 26 are directed outwardly. They form a circular ring-shaped support face for the absorber element 18, with which the latter is supported on the door panel 12. In addition, the absorber element 18 may be fastened on the door panel 2 by means of a weld seam 28. Alternatively, gluing, riveting or another connection method is also possible.

For further stabilisation of the fastening device according to the invention in the event of an accident, a guide is additionally provided here, for example two pins 30, which also extend through respective opposing openings in the door hinge 10 and the door panel 12. Furthermore, these pins 30 are supported on the inside of the side walls 20 of the absorber element 18 and thereby stabilise the latter.

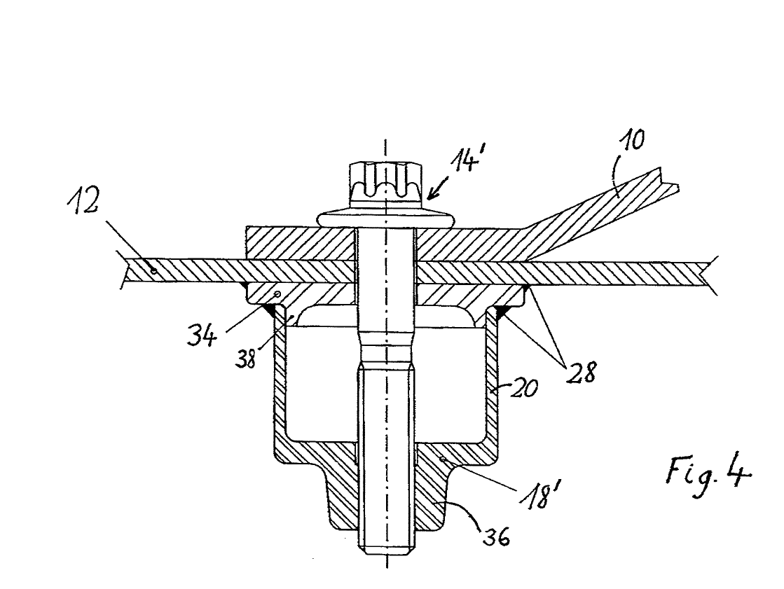

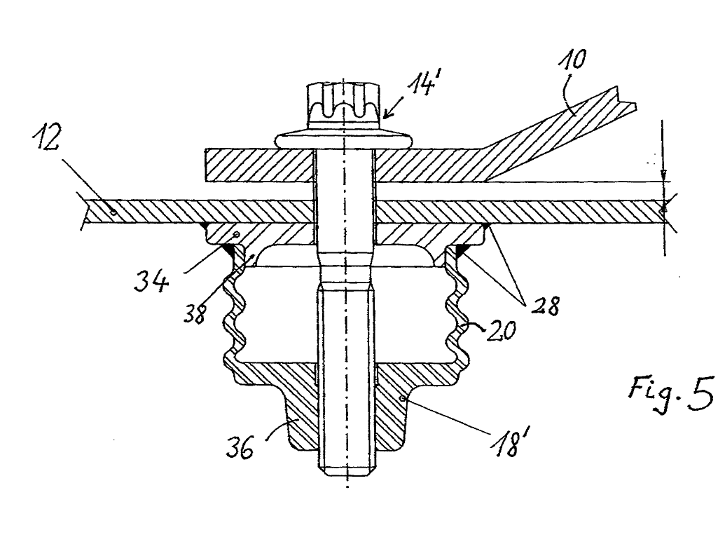

The pins are shown here with a circular cross-section. However, they may also have another cross-section if this is structurally advantageous. The pins may be fastened here in a press fit in the door panel 12 or in the hinge 10, or be glued there. The number of pins 30 is variable here; two, three or four pins may be provided and, in the event of lower requirements for preventing the fastening device from tilting in the case of a collision, the pins 30 can also be dispensed with completely, as the embodiment of FIGS. 4 and 5 will show below, by way of example.

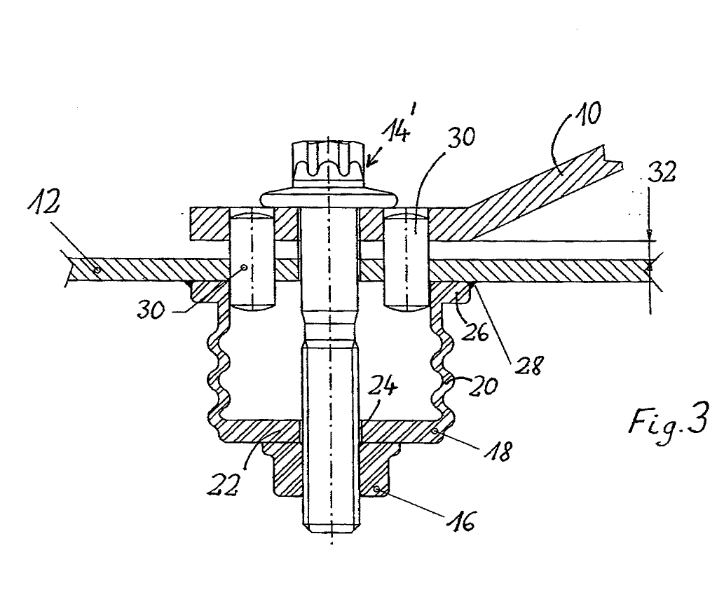

FIG. 3 shows the fastening device of FIG. 2 according to the invention after an accident, for example a side impact against the door fastened with the device according to the invention.

The absorber element 18 has been deformed here by compression of the side walls 20, energy having been absorbed accordingly. A spacing “crumple zone” 32 has formed between the door hinge 10 and the door panel 12, the size of which depends on the energy absorbed and the configuration of the side walls 20 of the absorber element 18. The pins 30 are still rigidly inserted in the door panel 12 and still guide the door hinge 10, so the latter cannot tilt, which otherwise generally leads to a jamming of the doors in the event of accidents.

As can be seen very nicely from this FIG. 3, the fastening device according to the invention leads to a controlled deformation with the absorption of energy and therefore to a controlled deformation event of the entire door region in the event of a side impact.

FIG. 4 shows a further embodiment of a fastening device according to the invention. The same reference numerals also designate the same components here as in FIGS. 1 to 3.

In the embodiment shown in FIG. 4, the nut 16 of FIGS. 2 and 3 is, however, replaced by a tube 36, into which an internal thread for the screw 14′ is introduced. In this manner, the absorber element 20 can be produced in one piece as a sheet metal formed part and the use of an additional nut 16 can be saved.

Furthermore, the absorber element 18′ shown is supported by means of a guide plate 34 on the door panel 12. The guide plate has the form of a circular disc, which has a circular attachment 38, which extends away perpendicularly from the door panel 12 and is used as an abutment for the side walls 20 of the absorber element 18′. The connection between the side walls 20 of the absorber element 18′ and the guide plate 34 is preferably ensured by a further weld seem 28. Furthermore, the absorber element 18′ can also be connected here by means of its guide plate 34 by a further weld seam 28 to the door panel 12.

Alternatively, the element can also be produced in one piece, a combination of FIGS. 2 and 4 with the tube 36 and the right-angled edge 26 in one element.

No pins (30) are provided in the embodiment shown here.

FIG. 5 shows the fastening device according to the invention of FIG. 4 after the loading by a side impact. The side walls 20 of the absorber element 18′ have also deformed here by absorbing energy. A lateral bending away of the absorber element 18′ is not prevented here by pins 30, but by the welding to the guide plate 34. The door hinge 10 and door panel 12 have also moved apart from one another here in a controlled manner by a spacing “crumple zone” after the collision-related loading.

If the absorption of energy of the absorber element 18, 18′ is to be increased in the two embodiments, the absorber element can be completely or partly filled with a plastics material foam, for example polyurethane foam.

1. Device for fastening side impact supports, door or flap hinges on the doors or flaps or on the bodywork of motor vehicles, with a screw, which extends through an opening in the door, the flap or the bodywork panel and an opening in the side impact support or hinge, and is secured by a nut, characterised in that arranged between the nut and the panel of the door, the flap or the bodywork or the side impact support or the hinge is a hollow absorber element, which is penetrated by the screw and has side walls, which substantially run parallel to the rotational axis of the screw, and two respective abutment faces running perpendicular to the rotational axis of the screw, wherein one abutment face is supported on the panel of the door, the flap or the bodywork or the side impact support or the hinge, while the other abutment face carries the nut.

2. Device according to claim 1, wherein the absorber element is hollow cylindrical, so the side walls form the lateral surface of the cylinder.

3. Device according to claim 1, wherein the side walls are configured with corrugated profile or are pre-compressed.

4. Device according to claim 1, wherein the absorber element has an inner space, which is completely or partly filled with foam, for example polyurethane foam.

5. Device according to claim 1, wherein the absorber element is welded to the panel of the door, the flap or the bodywork or the side impact support or the hinge.

6. Device according to claim 1, wherein the abutment face, which faces the panel of the door, the flap or the bodywork or the hinge, of the absorber element is formed by a guide plate welded, soldered, riveted or glued to the side walls.

7. Device according to claim 1, wherein the abutment face, which faces the panel of the door, the flap or the bodywork or the side impact support or the hinge, is formed by a right-angled folded edge of the side walls.

8. Device according to claim 1, wherein the nut is welded to the abutment face facing it.

9. Device according to claim 1, wherein the panel of the door, the flap or the bodywork and the hinge are in each case provided with one or more openings, which in each case oppose one another in the assembled state, are of virtually the same size and through which pins or other guide elements, such as bolts, are inserted in the assembled state.

10. Device according to claim 9, wherein the pins are additionally supported on the inner face of the side walls.

11. Device for fastening side impact supports, door or flap hinges on the doors or flaps or on the bodywork of motor vehicles using a screw, which extends through an opening in the hinge and an opening in the door, the flap or the bodywork panel, characterised in that the screw additionally extends through a hollow absorber element, which has side walls, which extend substantially parallel to the rotational axis of the screw, an abutment face, which runs perpendicular to the rotational axis of the screw and is supported on the panel of the door, the flap or the bodywork or the side impact support or the hinge, and an internal thread for the screw on the side opposing the abutment face.

12. Device according to claim 11, wherein the absorber element is hollow cylindrical, so the side walls form the lateral surface of the cylinder.

13. Device according to claim 11, wherein the side walls are configured with a corrugated profile or are pre-compressed.

14. Device according to claim 11, wherein the absorber element has an inner space, which is completely or partly filled with foam, for example polyurethane foam.

15. Device according to claim 11, wherein the absorber element is welded, riveted or glued to the panel of the door, the flap or the bodywork or the hinge.

16. Device according to claim 11, wherein the abutment face of the absorber element is formed by a guide plate welded, riveted or glued to the side walls.

17. Device according to claim 11, wherein the abutment face is formed by a right-angled folded edge of the side walls.

18. Device according to claim 11, wherein the absorber element is produced as a sheet metal formed part, and the internal thread is configured in a tube.

19. Device according to claim 11, wherein the panel of the door, the flap or the bodywork and the side impact supports or the hinge are in each case provided with one or more openings, which in each case oppose one another in the assembled state, are virtually the same size and through which pins or other guide elements, such as bolts, are inserted in the assembled state.

20. Device according to claim 19, wherein the pins are additionally supported on the inner face of the side walls.
